(19) United States
(12) Patent Application Publication
(10) Pub. No.: US 2002/0035636 A1
(43) Pub. Date: Mar. 21, 2002

(54) Computer and process for the provision of distributed dynamic services for mobile terminal devices

(75) Inventors: Martin Gitsels, Munich (DE); Jochen Sauter, Munich (DE)

Correspondence Address: STAAS & HALSEY LLP, 700 11TH STREET, NW, SUITE 500, WASHINGTON, DC, 20001, US

(73) Assignee: Siemens Aktiengesellschaft, Munich (DE)

(21) Appl. No.: 09/950,807

(22) Filed: Sep. 13, 2001

(30) Foreign Application Priority Data
Sep. 13, 2000 (DE) 100 45 248.5

(51) Int. Cl. G06F 15/16

(52) U.S. Cl. 709/230; 709/227; 709/218

(57) ABSTRACT

A request message, which is coded in a markup language, is decoded, and the stored service parameters are selected which are allocated to the distributed dynamic service requested in the request message. The selected service parameters are transmitted in the markup language to a terminal device and parameters values are allocated to the service parameters and are transmitted to the computer. The parameter values are transmitted to a service server, and the requested service is performed according to the parameter values. The result of the performance, for example a message to the user, is transmitted from the computer in the markup language and redirected to the terminal device.

### CROSS REFERENCE TO RELATED APPLICATIONS

This application is based on and hereby claims priority to German Application No. 100 45 248.5 filed on Sep. 13, 2000 in Germany, the contents of which are hereby incorporated by reference.

### BACKGROUND OF THE INVENTION

The invention relates to a computer and a process for the computer-supported provision of distributed dynamic services for mobile terminal devices, in particular for small mobile terminal devices.

Such a computer and such a process are known; in the case of such a computer for the provision of distributed dynamic services in a computer network, it is provided to install a Java Virtual Machine (JVM) on the corresponding computer.

“Distributed dynamic services” is to be understood to mean, for example, services with which a terminal device can call spontaneously, i.e., without pre-configuration, upon a predetermined service of a service server.

Various technologies exist for the management of dynamic services in networks. An example of such a technology for the management of distributed dynamic services is Jini, which is known from a first reference obtainable on the Internet on Aug. 1, 2000, under the address: http://www.sun.com/jini.

Further similar technologies are Universal Plug and Play (see a second reference obtainable on the Internet on Aug. 1, 2000, under the address: http://www.upnp.org), and also Chai (see a third reference obtainable on the Internet on Aug. 1, 2000, under the address: http://www.internetsolutions.enterprise.hp.com/chai)

According to the system known from the first reference, service servers which wish to make a Jini service available for a communication terminal device log-on to a so-called Jini Lookup Service.

According to the Jini protocol, a Jini client requests from the Jini Lookup Service a list of the Jini services available on the computer network.

A list of available services is transmitted from the Jini Lookup Service to the Jini client as a services message.

Service parameters are allocated to each Jini service: for example, different attributes which characterize the respective service, such as for example the name of the service, detailed information about the service, or else the address of the services server within the computer network. As a further attribute, for example, a page in a markup language, for example the Hypertext markup Language (HTML) or the Wireless Markup Language (WML), can be made available to the Jini Lookup Service as the service parameter.

Furthermore, for each registered service, a so-called service proxy is stored is stored in the Jini Lookup Service as an independent program, and can carry out its own communication directly with the Jini service server.

When the Jini client selects a service, the Jini Lookup Service sends the service proxy to the Jini client, and the service proxy is stored by the Jini client.

Using the Jini proxy, a communication with the Jini services server is usually set up by the Jini client, and the desired service is requested by the Jini client and usually provided by the Jini services server.

The Jini client is usually implemented in the user's computer using the Java Virtual Machine and the Jini software.

This procedure has the disadvantage that considerable computing time is required for the use of the Jini service on the respective client computer. In particular, a Java Virtual Machine according to the Java 2 specification (see Obtainable on the Internet on Aug. 1, 2000, under the address: http://java.sun.com/jdk) also has to be installed on the respective client computer.

In particular, it has not heretofore been possible to call upon Jini services on computers having little computing capacity, for example, a mobile communication terminal device such as a mobile radiotelephone or a PDA (Personal Digital Assistant), since no Java Virtual Machine according to the Java 2 specification existed heretofore for such communication terminal devices.

This problem is further complicated in that carrying out of Jini services without use of the Wireless Application Protocol (WAP) is not practicable because mobile radio connections make only a low data rate available.

### SUMMARY OF THE INVENTION

One potential object of the invention is to provide distributed dynamic services in a computer network with low bandwidth, even for computers with low available computing capacity.

The object is attained by a computer and also by a process for the provision of distributed dynamic services in a computer network.

A computer for the provision of distributed dynamic services in a computer network, in particular for the provision of Jini services, has stored service parameters which are allocated to the distributed dynamic services available in the computer. The computer has a markup language coding/decoding unit, with which the messages in a markup language can be coded and decoded.

Furthermore, there is provided in the computer a service identification unit with which, based on the received coded request message which is coded in a markup language, stored service parameters are selected which are allocated to the distributed dynamic services requested in the request message.

With a service protocol coding/decoding unit furthermore provided in the computer, it is possible to code and decode according to a service protocol, in particular the Jini protocol, according to which distributed dynamic services can be operated.

The markup language coding/decoding unit is arranged such that the service parameters selected by the service parameter identification unit can be coded in the corresponding markup language.

Furthermore, parameter values which were supplied to the service parameters in a response message to the computer, and which describe the respective service in its request in more detail, are coded by the service protocol coding/decoding unit according to the service protocol.

Furthermore, the computer has a services computer identification unit with which those further computers in the computer network are identified which provide one or more services according to the service protocol, preferably according to the Jini protocol.

The services computer identification unit can preferably be implemented as the Jini Lookup Service.

In the Jini Lookup Service, Jini services can directly log-on, in order thereby to make possible a direct communication between the services identification unit and the Jini Lookup Service.

In a process for computer-supported provision of distributed dynamic services in a computer network, in which service parameters which are allocated to distributed dynamic services available in the computer network are stored in a computer, a request message which is coded in a markup language is received and decoded by the computer. Depending on the service which is selected with the request message, the stored service parameters are selected which are allocated to the requested distributed dynamic service. The selected service parameters are coded to a service parameter message according to the markup language and are transmitted to a communication transmitting device.

For example, parameter values are allocated to the service by the user of the communication transmitting device. The parameter values are coded into a value message in the markup language and transmitted to the computer. After the value message has been decoded, a service request message based on the parameter values and the requested service, according to a service protocol according to which distributed dynamic services can be processed, is transmitted by the computer with the corresponding parameter values to the services server, and the requested service is produced by the services server according to the previously determined parameter values. The respective services servers are identified and stored by the computer, preferably with the use of a Jini Lookup Service.

It should be apparent that it is now no longer necessary to implement software modules which directly implement the Jini protocol, in a computer with low computing capacity, for example, a communication transmitting device, particularly a mobile communication transmitting device such as a mobile radiotelephone or a PDA.

The mobile communication transmitting device, in general the computer with low computing capacity, can carry out a communication with a protocol conversion computer, the computer according to the invention, according to a conventional Internet protocol, for example, the Hypertext Transfer Protocol (HTTP) or the Wireless Application Protocol (WAP).

In the computer, the conversion of the Internet protocol to the Jini protocol takes place, making possible the interposition of the computer, “transparently” for the communication transmitting device.

In view of the above, it is now possible for the first time to find and call upon Jini services in a simple manner, even from a computer having low computing power, for example, on a mobile communication transmitting device such as a mobile radiotelephone or a PDA.

The markup language coding/decoding unit can be arranged so that messages in the Hypertext Markup Language (HTML) or in the Wireless Markup Language (WAP) can be coded and decoded.

Furthermore, the service protocol coding/decoding unit can be arranged so that messages according to the Jini service protocol can be processed according to the distributed dynamic services and can be coded and decoded.

According to one development, it is provided that, at the beginning of or during the provision, the distributed dynamic services available or newly available on the computer network can be identified, for example by a services identification unit, and can be identified and stored, with the respective service parameters allocated to them, by the computer.

The services identification unit and/or the services protocol coding/decoding unit can be arranged as a Java servlet.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a block diagram in which the general architecture of a communication system according to an embodiment example of the invention is illustrated;

FIG. 2 shows a block diagram in which individual messages for the identification of Jini services according to an embodiment example of the invention are shown;

FIG. 3 shows a block diagram in which the selection and use of Jini services according to an embodiment example of the invention are shown.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

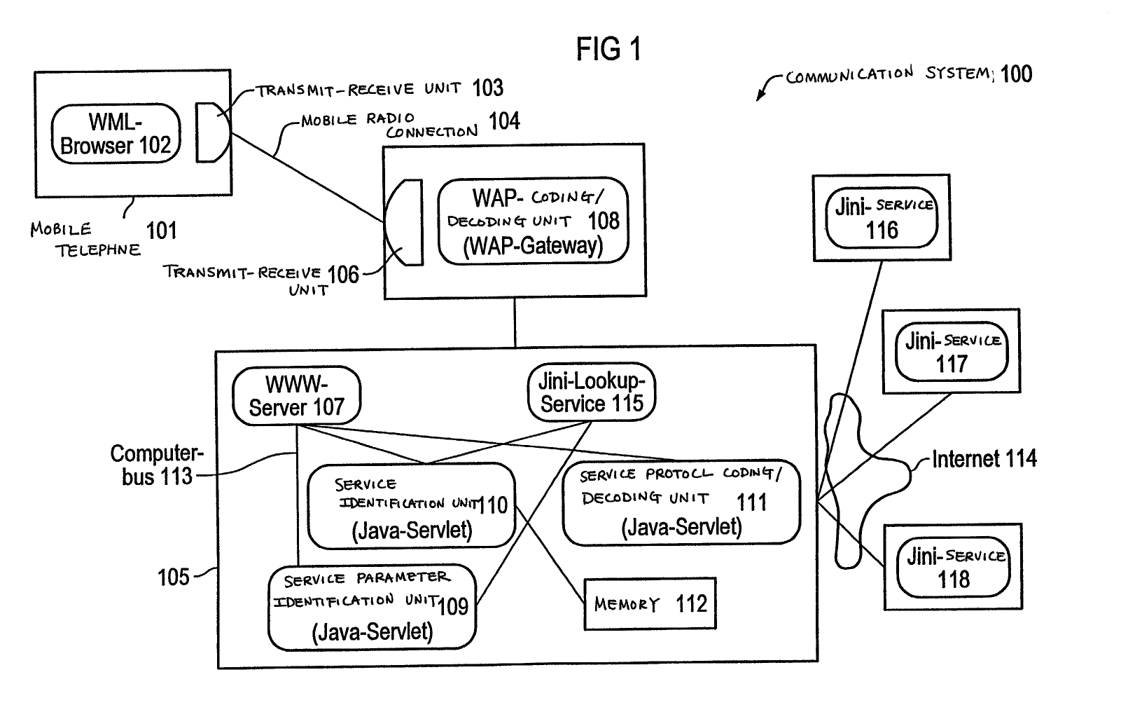

FIG. 1 shows a communication system 100 with a mobile radiotelephone 101, a protocol conversion computer 105, a WAP coding/decoding unit 108 and with n service servers: a first Jini server 116, a second Jini server 117, and a n-th Jini server 118.

The mobile radiotelephone 101 is coupled via a mobile radio connection 104, for example using GSM, CDMA or UMTS, and by the WAP coding/decoding unit 108, to the protocol conversion computer 105.

The protocol conversion computer 105 is coupled to the Jini servers 116, 117, 118 by a communication network: the Internet 114, according to the embodiment example.

This means that the communication between the mobile radiotelephone 101 and the protocol conversion computer 105 takes place according to the Wireless Application Protocol (WAP) on the application layer—protocol plane by the WAP coding/decoding unit 108 and according to the respective mobile radio protocol according to the respectively used mobile radio standard.

The communication between the protocol conversion computer 105 and the Jini servers 116, 117, 118 takes place on the application layer—protocol plane according to the Jini protocol, as described in the first reference, and on the plane of the transport layer or the switching layer according to the internet protocols, Transport Control Protocol (TCP) or Internet Protocol (IP).

A Wireless Markup Language browser (WML browser) is installed in the mobile radiotelephone 101, which has a processor and also a memory (not shown). By the WML browser 102, it is possible to send messages from the mobile radiotelephone 101 according to the WAP standard, and to decode received messages which contain data according to the WML standard and to display them to the user of the mobile radiotelephone 101.

Furthermore, the mobile radiotelephone 101 has a transmitter/receiver unit 103 by which communication takes place with the protocol conversion computer 105 via the mobile radio connection 104 by the WAP coding/decoding unit 108, that is, is received from the messages sent to the protocol conversion computer 105 and from the messages which were sent from the protocol conversion computer 105.

The protocol conversion computer 105 likewise has a transmitter/receiver unit 106, and also a World Wide Web server (WWW server) 107, via which a communication is made possible by the WAP coding/decoding unit 108 with the WML browser 102 of the mobile radiotelephone 101.

Messages which are to be transmitted to the mobile radiotelephone 101 are coded with the WAP coding/decoding unit 108 according to the WAP protocol, and are transmitted by the transmitter/receiver unit of the protocol conversion computer 105 to the mobile radiotelephone 101. Furthermore, messages transmitted from the mobile radiotelephone 101 are decoded by the WAP coding/decoding unit.

Furthermore, a service parameter identification unit 109 is contained in the protocol conversion computer 105; its functionality is described in more detail during the description of the process.

Jini services which are available on the computer network are identified in the services identification unit 110 of the protocol conversion computer 105.

Furthermore, a service protocol coding/decoding unit is provided as the Jini protocol coding/decoding unit 111, which codes and sends messages according to the Jini protocol from the protocol conversion computer 105 to the Jini servers 116, 117, 188 or to the Jini lookup service computer 115, which is likewise coupled to the Internet 114. Furthermore, the service protocol coding/decoding unit is arranged so that received messages can be decoded according to the Jini protocol.

Furthermore a processor and a memory are provided in the protocol conversion computer 105.

The individual elements in the protocol conversion computer 105 are connected together by a computer bus 113.

Furthermore, it is provided in an alternative embodiment of the invention to implement the individual components in common in software in the form of a computer program, the functionality of the respective unit remaining ensured by the processor of the protocol conversion computer 105 when the computer program is executed.

The service protocol coding/decoding unit 111 is realized according to the present embodiment example as a so-called Java servlet, that is, as a Java software module, which communicates directly with the WWW server 107 according to a known protocol.

A Java servlet receives request messages according to the Hypertext Transport Protocol (HTTP), processes these possibly with the aid of external server processes, for example a database server, and produces results for the user's browser: according to the embodiment example, for the WML browser 102 of the mobile radiotelephone 101.

The servlet concept functions equally for Web access via a conventional HTML-capable browser, for example a Netscape Navigator, and also for a communication connection according to the WAP by a so-called micro-browser which uses WML as the markup language.

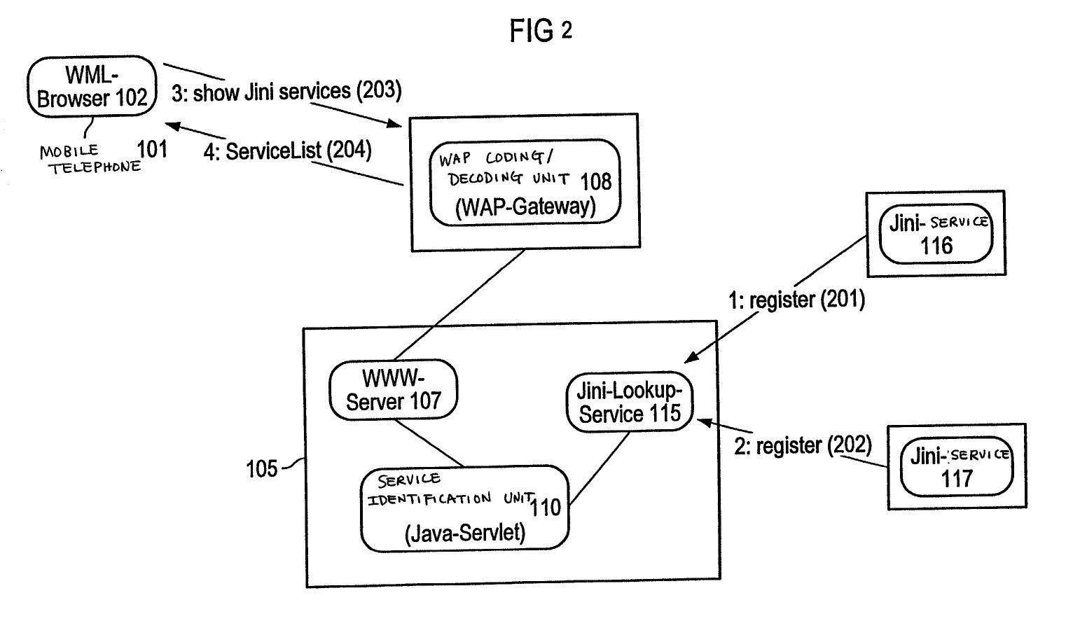

FIG. 2 shows the procedure according to the embodiment example for the identification of the Jini services which are available in the computer network, the Internet 114, and are made available by Jini servers 116, 117, 118.

Before a user can have access to Jini services, he must first find all services available on the computer network, particularly on the portion of the computer network which is accessible to him.

This takes place in the manner shown in FIG. 2.

Each Jini server 116, 117, 118 is registered in a lookup service by a registration message, that is, the first Jini server 116 is registered by a first registration message 201, and the second Jini server 117 is registered by a second registration message 202.

The registration messages 201, 202 are received and stored in the lookup service 115.

Plural attributes which describe the respective available service are respectively contained in the registration messages 201, 202.

Attributes are, for example, the name of the available service, location information of the service, or else a URL address of the Jini server 116, 117, 118.

Furthermore, according to the Jini protocol, a so-called service proxy, that is, a reference to the corresponding service object, is contained in the registration message, whereby a direct communication of the user of the service proxy with the service server becomes possible without interposition of the Jini lookup service 115.

According to the embodiment example, a further attribute which is allocated to the respective Jini service is a WML page which is allocated as the service parameter to the respective service.

If the Jini service is for example a printing service, which is placed at the disposal of a computer by a printer, the WML page of the corresponding printer service is comparable to a graphical user interface which is for example contained with the print option in a word processor program, and by which the number of prints, exact specification of the pages to be printed, etc., is possible by allocation of parameter values.

The service identification unit 110 uses the Jini lookup service 115 which is provided, that is, implemented, on the same computer, in order to make available a list of the Jini services registered there. This can occur either on inquiry by the client or periodically at fixed time intervals.

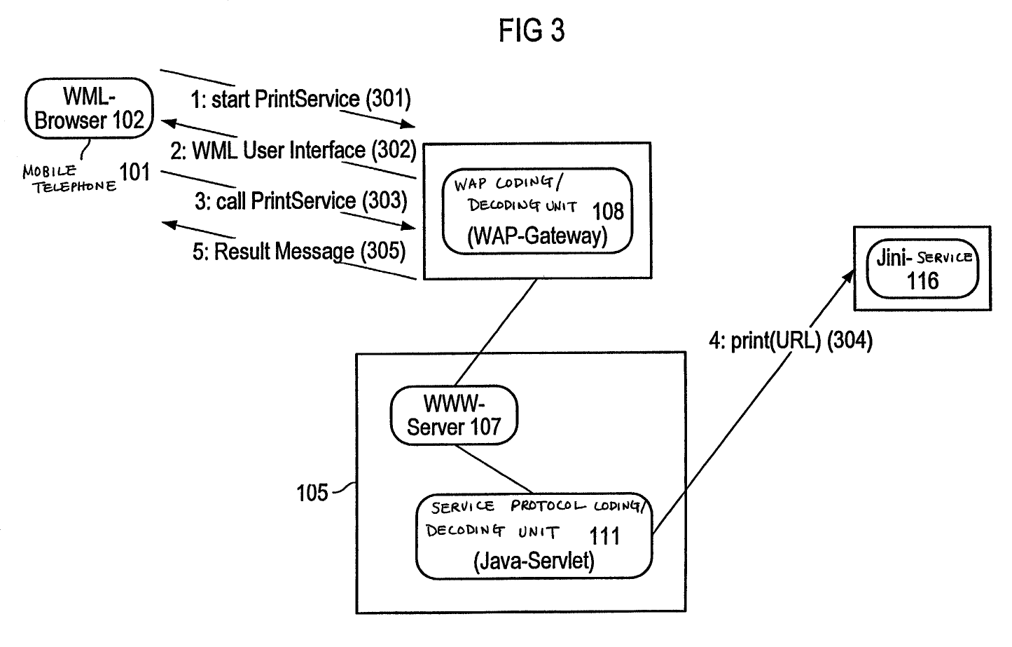

If now a user of the mobile radiotelephone 101 wishes to call up a Jini service, the sequence shown in FIG. 3 results.

The WML browser 102 of the mobile radiotelephone transmits a report request message 203, codes according to the WAP, to the protocol conversion computer 105.

All the available services are identified by the service identification unit 110, and are coded according to the WAP in a report message 204 and transmitted to the mobile radiotelephone 101.

They can furthermore be made available selectively according to the WAP protocol as selectable services according to the WML.

Alternatively, the identification of the list of available Jini services can take place in that a user of the mobile radiotelephone 101 requests an access page, also called a Jini portal, by the WML browser 102.

Alternatively, the access page can also be referenced to a general portal of an intranet of an enterprise, or of a town or region.

If now one of the hyperlinks is selected with which the Jini services in the report message 204 are shown by the WML browser 102 on the display of the mobile radiotelephone 101, a request message 301 with the data of the requested service is coded by the WML browser 102 and is transmitted via the WAP coding/decoding unit 108 to the protocol conversion computer 105.

Decoding of the request message 301 takes place in the protocol conversion computer 105, and the information, that is, the data concerning the desired service, is identified.

Using the service parameter identification unit 109, for the identified service, the corresponding stored service parameter allocated to the service, in particular the WML page which is allocated to the service, is identified, and is transmitted as a service parameter message 302 to the mobile radiotelephone 101, where the WML page is shown on its display by the WML browser 102.

The user can now enter the desired parameter values for the selectable and configurable service parameters, for example, in the case of a printing service, the file path of the document to be printed, the number of pages to be printed, or alternatively a URL (Uniform Resource Locator) for the document when the page is to be identified via the Internet before the printing process proper is requested.

The entered values are coded according to the WAP and are transmitted as a value message 303 via the WAP coding/decoding unit 108 to the protocol conversion computer 105.

A service request message 304 is now coded by the service protocol coding/decoding unit according to the Jini protocol, and is transmitted to the Jini servers 116, 117, 118; to a printer server, according to the embodiment example.

The respective services proxy of the service, which is stored in the memory 112 of the protocol conversion computer 105, is used for implementation. After successful printing, that is, after a successful performance of the requested printing service according to the parameter values which were provided beforehand by the user of the mobile radiotelephone 101 and also were transmitted to the printer servers 116, 117, 118 in the service request message 304, a result message 305 is coded by the protocol conversion computer 105 according to the WAP format and is transmitted by the WAP coding/decoding unit 108 to the mobile radiotelephone 101.

The result message 305 contains either the successful performance of the service or an error message, so that the mobile radiotelephone 101 receives the information as to whether or not the service could be carried out.

A scenario by way of example is briefly given hereinbelow.

The user of the mobile radiotelephone has identified a page of interest to him on the Internet 114 by the WAP; for example, a review of present stock market prices.

He saves the hyperlink, that is, the URL of the page with the stock market prices, in the memory of the mobile radiotelephone 101.

If the user of the mobile radiotelephone 101 now comes to be near a printer which has a Jini printer service available, the user of the mobile radiotelephone 101 can now, in a simple manner according to the procedure described above, have the desired internet page printed out by the printer which serves as a Jini printer server.

The invention has been described in detail with particular reference to preferred embodiments thereof and examples, but it will be understood that variations and modifications can be effected within the spirit and scope of the invention.

What is claimed is:

1. A computer system for the provision of distributed dynamic services in a computer network, wherein service parameters are stored in the computer which are allocated to distributed dynamic services available on the computer network, comprising:
a service identification unit, with which, based on a received, decoded request message which is coded in a markup language, a service parameter is selected which is allocated to the distributed dynamic service requested in the request message,
a service protocol coding/decoding unit, with which the messages can be coded and decoded according to a service protocol according to which distributed dynamic services can be processed,
wherein the service parameters selected by the service identification unit can be coded in the markup language by a markup language coding/decoding unit,
wherein decoded parameter values of the service parameter can be coded according to the service protocol by the service protocol coding/decoding unit, and
with a service computer identification unit, with which further computers in the computer network are determined, which provide the one or more services according to the service protocol.

2. A computer system according to claim 1, wherein
the markup language coding/decoding unit is arranged so that messages in the markup language Hypertext Markup Language and/or in the markup language Wireless Markup Language can be coded and decoded.

3. A computer according to claim 1, wherein
the service protocol coding/decoding unit is arranged so that messages according to the Jini service protocol, according to which distributed dynamic services can be processed, can be coded and decoded.

4. A computer according to claim 2, wherein
the service protocol coding/decoding unit is arranged so that messages according to the Jini service protocol, according to which distributed dynamic services can be processed, can be coded and decoded.

5. A computer system according to claim 1, wherein
with a service identification unit, with which the distributed dynamic services can be identified which are available on the computer network, and with which service parameters which are respectively allocated to a service can be identified.

6. A computer system according to claim 4, wherein
with a service identification unit, with which the distributed dynamic services can be identified which are available on the computer network, and with which service parameters which are respectively allocated to a service can be identified.

7. A computer system according to claim 1, wherein the service computer identification unit and/or the service protocol coding/decoding unit is/are arranged as a Java servlet.

8. A computer system according to claim 6, wherein
the service computer identification unit and/or the service protocol coding/decoding unit is/are arranged as a Java servlet.

9. A computer system according to claim 1, wherein
the service computer identification unit provides a Jini lookup service.

10. A computer system according to claim 8, wherein
the service computer identification unit provides a Jini lookup service.

11. A process for the computer-supported provision of distributed dynamic services in a computer network, wherein service parameters which are allocated to distributed dynamic services available on the computer network are stored in a computer, comprising:
receiving and decoding a request message, which is coded in a markup language;
selecting the stored service parameters which are allocated to the distributed dynamic services requested in the request message,
transmitting the selected service parameters on a communication transmitting device as a service parameter message coded in the markup language,
allocating parameter values in the communication transmitting device to the service parameters,
transmitting at least the parameter values to the computer as a value message coded in the markup language,
decoding the value message,
transmitting a service request message according to a service protocol, according to which distributed dynamic services can be processed, the service request message being transmitted with the parameter values to a service server, the service server having been identified by the computer, and
performing the requested service is performed according to the parameter values.

12. A process according to claim 7, wherein
the Hypertext Markup Language and/or the Wireless Markup Language is/are used as the markup language.

13. A process according to claim 11, wherein
the Jini service protocol is used as the service protocol.

14. A process according to claim 12, wherein
the Jini service protocol is used as the service protocol.

15. A process according to claim 11, wherein
the distributed dynamic services available on the computer network can be identified and with which the service parameters which are allocated to a respective service are identified.

16. A process according to claim 14, wherein
the distributed dynamic services available on the computer network can be identified and with which the service parameters which are allocated to a respective service are identified.

17. A process according to claim 9, wherein
one or more Java servlets are used for the identification of the services in the computer and/or for coding and/or decoding messages into the service protocol and/or from the service protocol.

18. A process according to claim 16, wherein
one or more Java servlets are used for the identification of the services in the computer and/or for coding and/or decoding messages into the service protocol and/or from the service protocol.
